(19) United States
(12) Patent Application Publication
(10) Pub. No.: US 2024/0215054 A1
(43) Pub. Date: Jun. 27, 2024

(54) COMMUNICATION SYSTEM AND USER DEVICE

(71) Applicant: Fraunhofer-Gesellschaft zur Foerderung der angewandten Forschung e.V., Munich (DE)

(72) Inventors: Thomas HAUSTEIN, Berlin (DE); Paul Simon Holt LEATHER, Berlin-Schlachtensee (DE); Lars THIELE, Berlin (DE); Norbert FRANKE, Erlangen (DE); Mohammad ALAWIEH, Erlangen (DE)

(21) Appl. No.: 18/405,794

(22) Filed: Jan. 5, 2024

Related U.S. Application Data
(63) Continuation of application No. PCT/EP2022/069138, filed on Jul. 8, 2022.

(30) Foreign Application Priority Data
Jul. 9, 2021 (EP) 21184834.6

(51) Int. Cl. H04W 72/40; H04L 5/00; H04W 64/00; H04W 76/10

(52) U.S. Cl. CPC H04W 72/40; H04L 5/0048; H04W 64/003; H04W 76/10

(57) ABSTRACT

Communication system comprising at least a first and second user device, wherein the first and the second user devices are configured to use a sidelink for a sidelink communication; wherein the first and the second user devices are configured to commonly perform device-to-device positioning or ranging while exchanging signals via the sidelink; wherein the communication system further comprises a coordinator; the coordinator configured to receive a sidelink-positioning request or to determine a sidelink-positioning demand and, in response to said request or to said sidelink-positioning demand, the coordinator is configured to coordinate the device-to-device positioning or ranging.

### CROSS-REFERENCE TO RELATED APPLICATIONS

This application is a continuation of copending International Application No. PCT/EP2022/069138, filed Jul. 8, 2022, which is incorporated herein by reference in its entirety, and additionally claims priority from European Application No. EP 21184834.6, filed Jul. 9, 2021, which is also incorporated herein by reference in its entirety.

Embodiments of the present invention refer to a communication system comprising at least a first and a second user device as well as to a first and a second user device. Further embodiments refer to a localization server. In general, embodiments are in the field of position determination within a communication system, especially within a communication system using sidelink communication.

### BACKGROUND OF THE INVENTION

FIG. 1 is a schematic representation of a system for implementing different services using the concept of network slices. The system includes physical resources, like a radio access network, RAN 100. The RAN 100 may include one or more base stations for communicating with respective users. Further, the physical resources may include a core network 102 having, e.g., respective gateways for connections to other networks, a mobile management entity, AMF, and a home subscriber server, HSS. A plurality of slices #1 to #n, also referred to as network slices, logical networks or logical subsystems, are implemented using the physical resources depicted in FIG. 1. For example, a first slice #1 may provide a specific service to one or more users. A second slice #2 may provide for an ultra-low reliable low latency communication, URLLC, with users or equipment. A third slice #3 may provide general mobile broadband, MBB, services for mobile users. A fourth slice #4 may provide for a massive machine type communication, mMTC. A fifth slice #5 may provide health services. Yet further slices #n may be provided for implementing other services. The slices #1 to #n may be implemented at the network side by respective entities of the core network 102, and access of one or more users of the wireless communication system to a service involves the radio access network 100.

FIG. 2 is a schematic representation of an example of a terrestrial wireless network 100 including, as is shown in FIG. 2(a), the core network 102 and one or more radio access networks RAN₁, RAN₂, . . . RAN_{N}. FIG. 2(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 2(b) shows an exemplary view of five cells, however, the RANₙ may include more or less such cells, and RANₙ may also include only one base station. FIG. 2(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands or bands including ITS bands (bands for Intelligent Transportation Systems) dedicated to V2X applications. Further, FIG. 2(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 2(b) by the arrows pointing to “core”. The core network 102 may be connected to one or more external networks. The external network can be the Internet, or a private network, such as an Intranet or any other type of campus networks, e.g. a private Wi-Fi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 2(b) by the arrows pointing to “gNBs”. A sidelink channel allows direct communication between UEs, also referred to as device-to-device, D2D, communication. The sidelink interface in 3GPP is named PC5. UEs can be mobile or stationary devices. Example for a stationary UE is a “UE-type-RSU”, a UE-type Road Side Unit as used for within V2X.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, the physical downlink, uplink and sidelink control channels, PDCCH, PUCCH, PSSCH, carrying for example the downlink control information, DCI, the uplink control information, UCI, and the sidelink control information, SCI. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 2 may be a heterogeneous network having distinct overlaid networks, e.g., a network of macro cells with each macro cell including a macro base station, like base station gNB₁ to gNB₅, and a network of small cell base stations, not shown in FIG. 2, like femto or pico base stations. In addition to the above-described terrestrial wireless network also non-terrestrial wireless communication networks, NTN, exist including spaceborne transceivers, like satellites, High Altitude Platform Systems (HAPS) and/or airborne transceivers, like unmanned aircraft systems. The non-terrestrial wireless communication network or system may operate in a similar way as the terrestrial system described above with reference to FIG. 2, for example in accordance with the LTE-Advanced Pro standard or the 5G or NR, new radio, standard.

In mobile communication networks, for example in a network like that described above with reference to FIG. 2, like an LTE or 5G/NR network, there may be UEs that communicate directly with each other over one or more sidelink, SL, channels, e.g., using the PC5/PC3 interface or Wi-Fi direct or a Bluetooth connection. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs can have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 2. This is referred to as an “in-coverage” scenario. Another scenario is referred to as an “out-of-coverage” scenario. It is noted that “out-of-coverage” does not mean that the two UEs are not within one of the cells depicted in FIG. 2, rather, it means that these UEs may not be connected to a base station, for example, they are not in an RRC connected state, so that the UEs do not receive from the base station any sidelink resource allocation configuration or assistance, and/or may be connected to the base station, but, for one or more reasons, the base station may not provide sidelink resource allocation configuration or assistance for the UEs, and/or may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2c is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 2. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2d is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2c, in addition to the NR mode 1 or LTE mode 3 UEs 202, 204 also NR mode 2 or LTE mode 4 UEs 206, 208, 210 are present. In addition, FIG. 2d, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2c and FIG. 2d illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and therefore it may contain information that does not form conventional technology that is already known to a person of ordinary skill in the art.

When using sidelink communication, the problem often occurs how the single user device (UE) should be enabled to perform position determination. An objective of the present invention is to provide a concept for position determination within a communication system (using at least partially sidelink communication), wherein the concept provides an improved approach for resulting positioning accuracy, avoidance of signalling overhead and applicability for different in or out of coverage scenarios.

### SUMMARY

An embodiment provides a communication system comprising at least a first and second user device, wherein the first and the second user devices are configured to use a sidelink for a sidelink communication. The first and the second user devices are configured to commonly perform device-to-device positioning or ranging while exchanging signals via the sidelink; wherein the communication system further comprises a coordinator; the coordinator is configured to receive a sidelink-positioning request or to determine a sidelink-positioning demand and, in response to said request or to said sidelink-positioning demand, the coordinator is configured to coordinate the device-to-device positioning or ranging. Note from the theoretical point of view each device can—according to embodiments—be the coordinator or can be selected as coordinator, i.e. the first or the second user device or the first and the second user device.

Another embodiment provides a user device forming a first or a second user device of a communication system comprising at least the first and the second user device, wherein the first and the second user devices are configured to use a sidelink for a sidelink communication. The first and the second user devices are configured to commonly perform device-to-device positioning or ranging while exchanging signals via the sidelink; wherein the communication system further comprises a coordinator; the coordinator configured to receive a sidelink-positioning request or to determine a sidelink-positioning demand and, in response to said request or depending or to said sidelink-positioning demand, the coordinator is configured to coordinate the device-to-device positioning or ranging. According to embodiment, the first user device may be the coordinator.

According to embodiments the device-to-device positioning or ranging may be specified as follows: Positioning is more into the direction of a 2D/3D positon, absolute on earth or relative to another item. Ranging is more like a 1D-distance, possibly combined with angular information (i.e. something you could measure from a single device).

Another embodiment refers to a method for coordinating a device-to-device positioning or ranging within a communication system. The method comprises the step of exchanging measurement resource configuration information or measurement configuration information between a coordinator and at least the second user device.

### BRIEF DESCRIPTION OF THE DRAWINGS

Embodiments of the present invention will be detailed subsequently referring to the appended drawings, in which:

FIG. 1 is a schematic representation of a system for implementing different services using the concept of network slices;

FIG. 2a-d schematic representations of examples of a wireless communication systems;

FIG. 3 shows a schematic representation of a basic implementation of a communication system according to embodiments;

FIG. 4 shows a schematic representation for illustrating sidelink positioning phases according to embodiments;

FIG. 5 shows a schematic representation on signalling and message exchange for a sidelink and downlink procedure for encourage mode; and

FIG. 6 illustrates schematically a representation on signalling and message exchange for a sidelink procedure using at least two UEs for measurement according to further embodiments; and

FIG. 7 illustrates schematically an example of a computer system according to an embodiment.

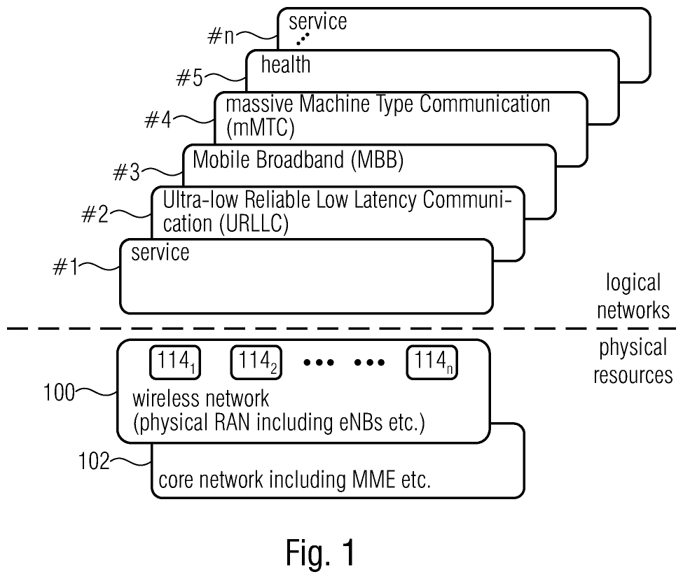

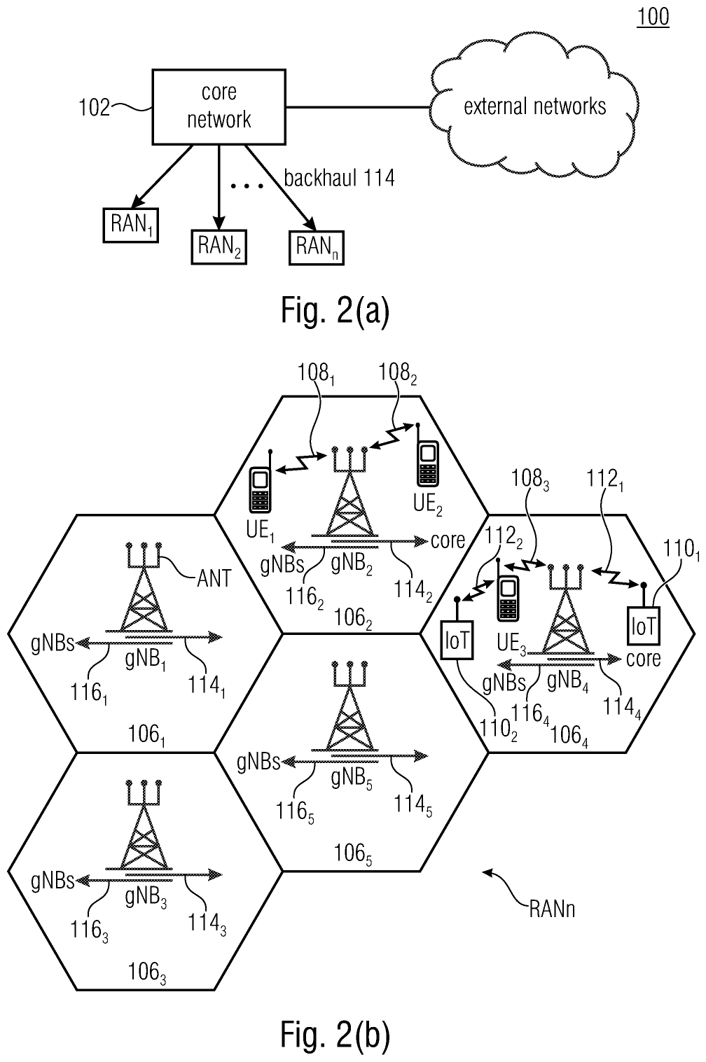

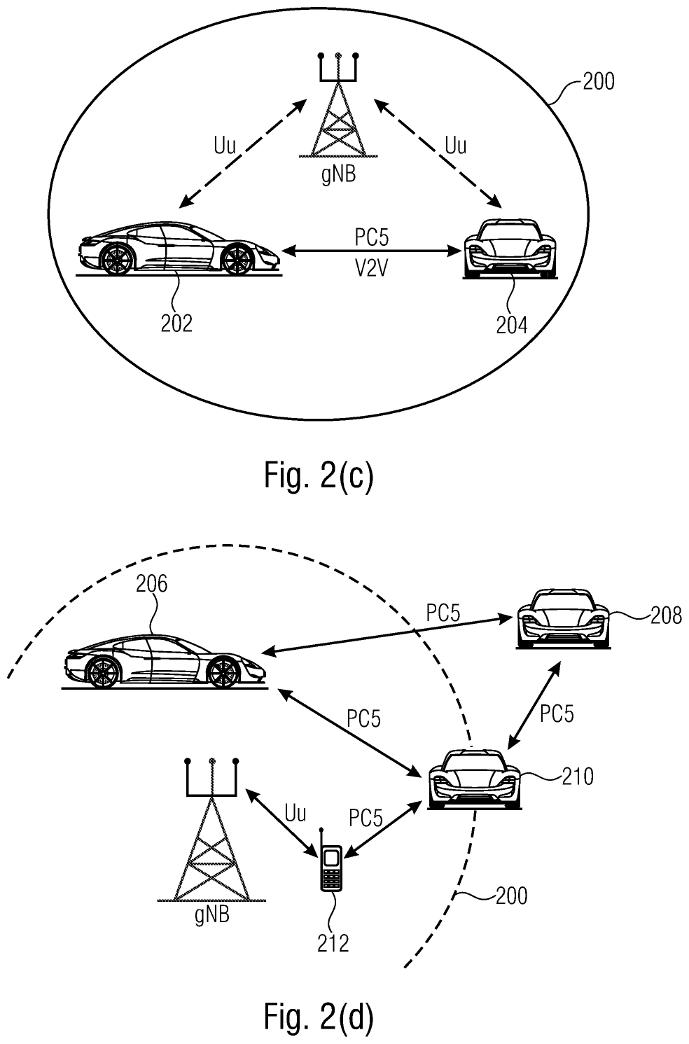

### DETAILED DESCRIPTION OF THE INVENTION

Embodiments of the present invention are now described in more detail with reference to the accompanying drawings in which the same or similar elements have the same reference signs assigned.

Before discussing embodiments of the present invention the detailed background especially the problem together with existing requirements will be discussed.

Localization, navigation in space and ranging between devices are valuable features in everyday life and in particular optimization of logistics, asset tracking, preventing hazards etc. Since decades the use of electromagnetic markers emitted from known positions e.g. as wireless beacons is well established and introduced in several standards. Such beacons can be dedicated for positioning tasks or indirectly exploited like e.g. RSSI measurements based in Wi-Fi AP SSID identification or in BLE. Advanced methods measure the “time-of-flight” (GPS, GNSS) or determine the “angle-of-arrival” of radio signals, such that the combination of single measurements (1D) can be used to obtain precise 2D or 3D positions (cf. https://ieeexplore.ieee.org/document/8692064 or https://www.sciencedirect.com/topics/engineering/angle-of-arrival). Besides several satellite-based positioning systems deployed world-wide or across particular regions, cellular communication systems can provide a good positioning coverage based on their communication coverage footprint.

Since later releases of 4G-LTE reference signals (RS) for positioning were introduced in order to allow positioning on the UE or network side or assisted by one of the two ends. For 5G-NR positioning was agreed to become an integral part of the wirelessly supported feature sets, including dedicated positioning RS to be introduced in the set of RS defined in 5G-NR.

Various positioning methods and combinations of them are exploited SOTA positioning and localization algorithms/methods, most or all of them relying on time-of-flight measurements from a transmitter to a receiver and additionally, if available a common time reference point (cf. Reference TS 38.305). Provided that line-of-sight or the multi-path environment is sufficiently stable and/or well-structured, TOF measurements between one or more beacons transmitted and/or received by a multitude of transmission-reception-points (TRP) sufficiently well-distributed in space at known positions allows to determine the position of a transmitting device and/or a receiving device possibly assisted by exploiting additional reference anchors in space.

In situations where such sufficient and reasonable distributed number of reference anchors is not given e.g. in street canyons with keyhole like radio propagation environment, strong multipath environments with fluctuating or missing LOS components or scenarios that include outdoor to indoor transitions, accuracy of cellular RS transmitted/received only by macro base stations may be reduced or limited below a tolerable threshold.

Furthermore, in many applications the absolute position of a device (wireless transmitter/receiver) is not of primary importance, instead the distance or relative positioning between two or more devices is of interest.

In case of device nearby to each other the proximity and the distribution of such wireless devices can be used to enable and/or improve the positioning task/performance.

This sub-section provides a quantitative assessment of the estimated spatial positioning accuracy that could be achieved as a function of system bandwidth and, in particular, with that which is available in 5G-NR:
20 MHz system bandwidth (18.6 MHz when using 1,200 subcarriers at 15 kHz SCS) is equivalent to 32 MHz sampling minimum rate at ADC, therefore allowing a maximum time resolution of 1/32 MHz=0.031 μs=31 ns
Given TOF=1 ns to be equivalent to 0.3 m distance travelled by light in vacuum we can conclude a theoretical limit of 31 ns*0.3 m=9.2 m.
Given a larger system BW of 100 MHz the positioning accuracy improves by a factor of 5 as well, resulting in a maximum TOF measurement accuracy of slightly below 2 m.
A further increase to e.g. 400 MHz would allow a further reduction to 50 cm.
As a logical consequence 2 GHz system BW provide a limit of 10 cm.
. . . add other “tricks” (e.g. interpolation) to improve the positioning resolution—this could be as much as a factor of ten/hundred? e.g., single anchor, time-of-flight, mmWave (28 GHz) carrier with 400 MHZ (OFDMA) BW→1 cm
limited sampling frequency could be partly overcome be interpolation but what could be named here is the relationship of bandwidth to the width of correlation peak of the correlation curve of an RS (=wide correlation peak equal to TOA uncertainty and the non-resolution of echoes, i.e. multipath). The relationship is inversely proportional.

The central task to be solved by means of exploiting device to device proximity (proximity means in this context close enough to exchange RS suitable for position and/or ranging purposes) is the determination of relative positions/distances between two or more devices and/or absolute positions between one or more devices and positioning anchors/reference point.

Furthermore, the proposed method should work in-coverage, partial coverage and out-of-coverage (OOC) of existing positioning and/or timing reference anchors—for example, cellular base stations, Wi-Fi Access Points (AP), BLE beacons etc. In particular in OOC scenarios, the methods of sidelink ranging help to improve the means of exploring the proximity of wireless devices, self-announcing/advertising of a device in an OOC scenario/area and to trigger other devices to send and/or receive RS, messages suitable to perform ranging and or positioning tasks. However, if sidelink-ranging (sidelink-positioning) is active, e.g. based on ToF, exact geometrical information (1D-distance) become available to assist for this purpose at a different level.

The proposed method in its baseline should be a method able to resolve/determine the 1D-distance between two terminals, even if the scenario if otherwise totally empty. In addition, for possible assistance, it may include other positioning methods and other wireless interfaces if available—for example, BLE beacons, Wi-Fi beacons, GPS or other suitable signals even if these are not providing or are only partially providing communication capability for at least one device. Other devices may for example be useful synchronization sources to execute ranging and/or positioning communication protocols in a simpler fashion or may provide other environmental information (like proximity) that could be used in a hybrid fashion to provide 1/2/3D-positioning result.

Furthermore, the method should scale well with the number of devices included/used for the positioning/ranging task and the positioning accuracy should scale well with wireless parameters as system bandwidth, RS distribution in time, frequency and space, number of fixed and/or virtual anchor points, number of devices etc. As an example, the method should provide higher ranging and/or positioning accuracy the more bandwidth is provides and the update rate (meas. rate) should be flexible to support fixed or mobile scenarios, etc.

Furthermore, the method should allow to work with and without common timing and location reference points, and/or in absence and/or presence of LOS between two or more devices. Here, the novelty is exploration/reconnaissance of the wireless environment and particular mutual link pairs and their properties and selection of the appropriate ranging and/or positioning scheme in a given scenario/link situation. This includes detection of timing and location anchors/reference points and their properties/suitability to assist in this ranging/positioning task.

Furthermore, the device-to-device positioning/ranging method should be based on existing sidelink communication methods and if needed, extensions/enhancements are needed these should be minimally invasive.

The below mentioned conventional technology documents (patent applications, current standardization documents) describe approaches which are used by the below described concept for sidelink-assisted positioning method(s).

In the 3GPP standard, the document TS 38.21x is relevant within which the sidelink mechanism, a sidelink configuration, synchronization and reference signals are described. Furthermore, the publication having the title “3GPP NR Sidelink Transmissions Toward 5G V2X” (https://ieeexplore.ieee.org/document/8998153) might be relevant giving an overview of current sidelink definition in 3GPP's 5G NR (no positioning or ranging yet).

Fraunhofer is the applicant of the WO2020119925 describing two UEs or multi-UE scenarios using sidelink assistant positioning. Here, a reference signal is used. This predates 5G NR positioning methods and reveals the background of the method.

Fraunhofer has further worked with various ranging schemes implemented in non-3GPP-systems. The highest variety of activity has been in the field of UWB (cf implementations from Time Domain, Decawave [DW1000]). Applications projects were carried out implementing positioning in swarms of DW1000 devices based on Two-way-ranging. Fraunhofer also worked with the Nanotron implementation that uses the principle of FMCW to perform ranging between mobile devices. Fraunhofer has also worked within 3GPP on “multi-RTT”, which can be regarded as a two-way-ranging scheme between UE and gNB. It is described in TS 38.305.

All the mentioned concepts may have the potential for improvements with regard to usability for different in coverage/out of coverage scenarios, usability for sidelink devices and signalling effort or do not meet the other above discussed requirements.

Consequently, the objective of the present invention is to provide a position determination approach for UEs within a communication system (especially a communication system configured for sidelink communication) having an improved trade off between position determination accuracy, usability for different in coverage/out of coverage scenarios and signalling effort.

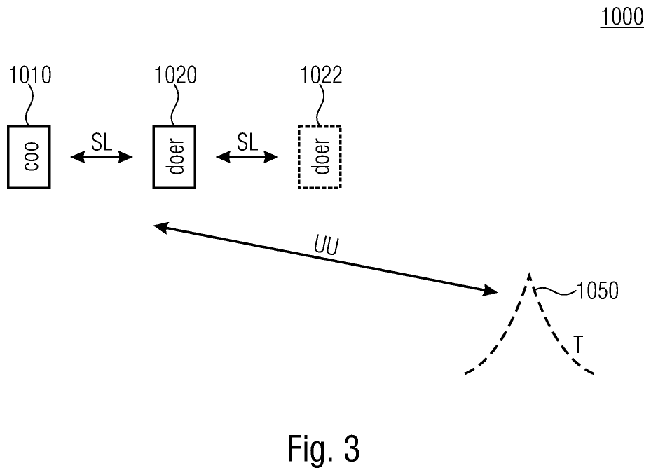

An embodiment providing a solution for this objective is formed by a communication system as it is illustrated by FIG. 3.

FIG. 3 shows a communication system 1000 comprising a first user device 1010, a second user device 1020 and an optional third user device 1022. All user devices are configured to use sidelink communication SL, i.e., to exchange signals via the sidelink SL. Furthermore, the communication system may optionally comprise a transmission point 1050, e.g., a base station, which is configured to communicate with the first, second, and further user equipment 1010, 1020, and 1022 using a Uu interface. Here, the Uu interface is illustrated for the communication between the first user equipment 1010 and the base station 1050.

For position determination a differentiation between the determination of an absolute or relative position of the single user devices 1010, 1020, and 1022 is made. For example, the distance between the user devices 1010, 1020, and 1022 may be determined as a relative position. According to a further example, the absolute position of one of the user devices 1010, 1020 and 1022, e.g., with respect to the position of the transmission point 1050 may be determined.

An advanced approach for position determination is to determine the position of one user equipment 1010, 1020 and 1022 by performing measurements between each other so as to use all or at least some UEs 1010, 1020 and 1022 as reference (absolute or relative reference). For example, one user device 1010, 1020 or 1022, for which the position (absolute position) may be known, can output a reference signal based on which a measurement can be performed by the other user equipment. This one example belongs to an approach called device-to-device positioning or ranging. According to embodiments, different measurements can be summed up under this term. Examples for these are:
two way ranging or two way ranging using a reference signal;
one way ranging with time anchor or one way ranging with time anchor using a reference signal;
one way ranging with signal strength anchor or one way ranging with signal strength anchor using a reference signal;
one way ranging based on RSSI path loss estimation or one way ranging based on RSSI path loss estimation using a reverence signal;
one-way or two-way ranging based on time-of-flight determination;
determining an angle of arrival and/or angle of departure;
determining a relative position or distance between the first and the second user device and/or determining an absolute position of the first or second user device or to determine a position of an anchor or of a reference point by use of one-way or two-way ranging;
determining a relative position or distance between the first and the second user device without time anchor, without reference anchor and/or an absence of line of sight between the first and the second user device and/or in the presence of ling of sight between the first and second user device by use of one-way or two-way ranging;
determining a relative position of the first user device with respect to another entity of the communication system or determining a relative position of the second user device with respect to another entity of the communication system; or
determining an absolute position by use of an anchor, or reference anchor, wherein an information on the anchor, or reference anchor is comprised by a measurement configuration information.

It should be noted that this device-to-device positioning or ranging is not limited to the above approaches, wherein this device-to-device positioning or ranging approach is typically performed commonly by the user devices, e.g., at least the user device 1010 and 1020. Note when just using two user device 1010 and 1020 without an anchor reference it is often just possible to determine a distance between the two devices 1010 and 1020. To improve the position determination additional measurements to other user devices, e.g., to the optional user device 1022 may be performed.

As discussed above, a typical problem is that the control signals/configuration signals for exchanging information about the resources or about the measurement have to be exchanged between the devices 1010, 1020 and 1022 of the communication system 1000. By use of these information the tasks of the device-to-device positioning/ranging are coordinated (e.g. it is determined which device outputs the reference signal and which device performs the measurement. According to a basic embodiment a so-called coordinator is used. The coordinator is configured to receive a sidelink position request or to determine a sidelink position demand and to coordinate the device-to-device positioning or ranging in response to said request or to said positioning demand. Alternatively, the coordinator may be defined as an UE supporting positioning of target UE, e.g., by transmitting and/or receiving reference signals for positioning, providing positioning-related information, etc., over the SL interface. Such a UE may be referred as an anchor UE for the coordinator functionalities.

According to embodiments, there are different possibilities for selecting the coordinator. According to an embodiment, one user device, here the user device 1010, has the role of the coordinator. Expressed in other words, this means that the first user equipment 1010 is configured to perform the coordination, especially the coordination of the device-to-device positioning and ranging performed within the network 1000. The other user devices 1020 and 1022 may act as doers, i.e., execute or support the D2D positioning/ranging as coordinated by the coordinator 1010.

The above-described concept can be summed up to a communication system comprising at least a first and a second user equipment 1010 and 1020, which are configured to use a sidelink for a sidelink communication. Furthermore, the two user equipments 1010 and 1020 are configured to commonly perform device-to-device positioning or ranging while exchanging signals via the sidelink SL. The communication system 1000 further comprise a coordinator C which is configured to receive a sidelink position request or to determine a sidelink position demand and, in response to said request or said sidelink position demand, to coordinate the device-to-device position or ranging. According to embodiments, the first user equipment 1010 comprises the coordinator/forms the coordinator.

For example, the coordinator or the first user device 1010 is configured to control the second user device 1020 with respect to the device-to-device positioning or ranging by use of a measurement resource configuration information and/or by use of a measurement configuration information. According to embodiments, the coordinator informs the second user device 2020 on one or more of the following information:
Sidelink positioning resource configuration;
measurement configuration;
report configuration;
transmission procedure;
measurement protocol;
measurement report.

According to enhanced embodiments, the coordinator is configured to participate at the D2D positioning/ranging (e.g. determine a position information for the second user device 1020), or to collect measurements for the second user device 1020 or another doer 1022. It can further forward or transmit a time anchor or a reference signal, to perform a measurement or to trigger a measurement event to be performed by the second user device 1020 or another doer 1022 or to trigger the second user device 1020 or another doer 1022. Another option is that the coordinator can provide a report on the device-to-device positioning or ranging or on a measurement of the device-to-device positioning or ranging.

According to further embodiments, the second user device 1020 is a doer configured to perform one or more parts of the device-to-device positioning or ranging. The second user device acting as doer may be configured to perform a part of the device-to-device positioning or ranging, e.g., a measurement or to provide a reference anchor, a reference signal, to forward a sidelink reference anchor, to forward a configuration information, to forward a measurement resource configuration information, to forward a measurement configuration information or to provide a report on the device-to-device positioning or ranging on a measurement of the device-to-device positioning or ranging.

Another embodiment provides a first user device 1010 of a communication system 1000, wherein the first user device 1010 is configured to act as a coordinator. According to embodiments, the first user device 1010 may be configured to
receive measurement resource configuration information including an information on a sidelink reference signal;
initiate/control/support the second user device based on the measurement resource configuration information;
receive a measurement configuration information;
apply the measurement configuration to perform the sidelink measurement together with the second user device (receive from the second user device the reference signal); and
report on the sidelink measurement.

Additionally or alternatively, the first user device 1010 may perform one of the following functionalities:
forwarding a sidelink measurement report from a second user device to the location server;
receiving a measurement report from a second user device and/or determining a range or distance related information;
receiving a first message including sidelink measurement report from a second device and a second message including information on a transmitted signal or/and received signal characteristics from the second user device; and
determining from the two messages an estimate related to position of the first on second device.

This means that when the first user device 1010 acting as a coordinator it may be configured to trigger the second user device 1020—starting from a sidelink positioning request or demand—to perform one or more of the following functionalities:
forwarding a sidelink measurement report from a second user device to the location server;
receiving a measurement report from a second user device and/or determining a range or distance related information;
receiving a first message including sidelink measurement report from a second device and a second message including information on a transmitted signal or/and received signal characteristics from the second user device; and
determining from the two messages an estimate related to position of the first on second device.

According to another embodiment, a second user device 1020 is provided which is configured to act as a doer. For example, it may be further configured to
receive measurement resource configuration information including an information on a sidelink reference signal from the coordinator;
receive a measurement configuration information from the coordinator;
apply the measurement configuration to perform the sidelink measurement together with the first user device.

According to further embodiments, a first and/or a second user device (as coordinator or doer) may be configured to:
forward a time anchor information; and/or to apply a range of sidelink information to determine either an absolute or common time anchor information; and/or the time anchor information is either based on a reference signal transmitted, received or transmitted and received from or to the reference time anchor;
report a measurement with respect to a reference anchor and/or perform a trigged transmission with respect to a reference anchor.

Another embodiment refers to a location server of the communication system, which is configured
to provide a measurement configuration information over a higher layer interface; or
to coordinate as coordinator or to provide measurement resource configuration information or to provide measurement configuration information.

Embodiments of the present invention are based on the finding that a number of components enable to prove the positioning, especially the concept of device-to-device positioning or ranging. The basic scheme is designed to be used between two UEs but also for scenarios, where their other network components are present and can assist. Within the communication system, e.g., comprising at least two UEs communicating via sidelink or changing signal via sidelink, a coordinator is selected, which coordinates the device-to-device positioning/ranging. Under the term device-to-device positioning/ranging all sidelink-enabled methods of positioning should be included/covered.

The above concept enhanced by the coordinator (previously known as master device) coordinating the doers (previously known as slave devices) has several advantages, namely that positioning support is given for the in coverage, partially in coverage and out of coverage scenarios. Furthermore, it enables sidelink-assisted positioning within 3GPP framework. An additional advantage is that signalling is reduced by forwarding time anchors. Another benefit of this concept is lower latency direct short-range positioning between devices and enabling precise in-swarm positioning (latency means the time taken to update a position/location; relevant to high-velocity use cases such as V2X).

Additional examples for device-to-device positioning/ranging are RSSI pathloss estimation, time or flight for one-way or two-way ranging, methods based on angle of arrival (AOA) or angle of departure (AOD). According to embodiments, a component of the device-to-device positioning/ranging comprise a concept of performing one way device to device ranging using common reference anchors, wherein this solution is supported by the coordinator in that way that the reference configuration or measurement configuration is provided or forwarded by the coordinator. This concept is extending in the second component—according to a further embodiment to include the forwarding of the reference anchor from a first device 1010 to a second device 1020 (and form a second device 1020 to a third device 1022 and so on). Yet a further extension to the concept is the use and inclusion of reference anchors that are not so-called 3GPP reference anchors. An additional solution component is a method of device to device ranging either with or without network assistance. A device to device (D2D) ranging without common reference anchors may be referred to as two way ranging. Further enhancements are the so-called resource allocation with regard to time/frequency grid. Neighbourhood ranging or group ranging (many UEs in a similar coverage area/region). Furthermore, the reference signal design may be adapted. Another option is the inter MNO ranging (inter-MNO (location/position estimation) operation: a bridge is needed between the sidelink devices and the orchestrator of the devices). All these concepts may lead to standardization in R18 or later of the 3GPP standard.

Another advantage of the concept of using the coordinator, e.g. UE 1010 as coordinator is, that the device-to-device positioning/ranging may be performed as in coverage-scenario, as out-of-coverage-scenario or partially out-of-coverage-scenario. According to embodiments, in the partially out-of-coverage-scenario the UE 1010 acting as coordinator may forward out anchor signal from a transmission point to the UEs 1020 which are out of coverage. According to embodiments, in the case of a complete out-of-coverage-scenario the UE 1010 acting as coordinator may use a standard configuration for the SL measurement resources and measurement configuration to perform the measurement with communication network formed by the UEs 1010, 1020 and 1020. Note the UE coordinator functionalities may be performed by an UE referred to as anchor UE (in differentiating it from the reference anchor).

Below, the above concept may be discussed in further detail taking reference to the different scenarios and different operation modes.

Before detailing each solution component, the use of the term out-of-coverage is defined in the context of this disclosure. This is needed since out-of-5G-network-coverage might ordinarily mean that a device is not connected to a (4G/5G) network. Here however, it means that a device is “not-covered” by the services or functions provided by other networks or devices. In this sense, coverage could also mean: GNSS coverage; Wi-Fi access coverage; Bluetooth coverage; UE-UE coverage; or multiple UE coverage.

(Note though) Note that in 3GPP standardization coverage usually means Uu-based network coverage. In scenarios with several UEs, there are out-of-coverage (all UEs not covered by Uu), partial-coverage (some UEs not covered by Uu) and in-coverage (all UEs covered by Uu) scenarios.

The above-described concept is enabled to be used in different operation modes. For example, they can be used for sidelink ranging modes. Here the device-to-device ranging may comprise the following steps:
UE-Coordinator 1010 in UE-based or NW-based modes may be formed by entity 1010
   UE-Coordinator 1010 coordinates with multiple other UEs, can perform one or more of the following:
      determine a second UE relative position information;
      collect measurements for Doer UEs;
      trigger transmission/measurement events
UE-Doer in UE-based or NW-based modes can be formed by the entity 1020.

The concept can be used for the following sidelink operation modes 1-6:
operation mode 1: at least one Doer and one Coordinator (in or out coverage)
operation mode 2: at least 2 Doers and a network (NW) entity, ex. LMF (in or out coverage)
operation mode 3: at least two Coordinators
operation mode 4: at least two devices (two Doers, two Coordinators, one Doer and one Coordinator) a TRP and NW entity (ex. LMF)
operation mode 5: at one Doers/Coordinators is in coverage and one Doers/Coordinators is out of coverage
operation mode 6: at least two devices (two Doers, two Coordinators, one Doer and one Coordinator) and a NW entity.

In the following subsection, examples are provided that illustrate not only how a similar device can be configured as either coordinator or doer, but also how a multiplicity of devices can be configured with different rules to then perform certain functions and operations.

According to a first embodiment, a UE acts as coordinator-UE-SL-B (master) and/or determines the range itself. Here, the UE 1010 or in general the coordinator:
receives a transmission configuration on a sidelink reference signal resource for transmission; and/or
transmit a configuration of least on sidelink reference signal resource to one or more UEs or reference anchor points based on the received configuration; and/or
receive a measurement configuration {SL-ToA, SL_RX-TX, RA_ToA . . . } on a on sidelink reference signal resource for transmission; and/or
apply the measurement configuration to receive one or more UE transmitted SL-RS to determine the signal propagation time and/or direction w.r.t one or more UEs.

According to further embodiments, the UE can act as a doer and/or reports the ranging measurement. Here, the UE:
receives a transmission configuration on a on sidelink reference signal resource for transmission; and/or
transmit a configuration of least on sidelink reference signal resource to one or more UEs or reference anchor points based on the received configuration; and/or
receive a measurement configuration on a on sidelink reference signal resource for transmission; and/or
apply the measurement configuration to receives one or more UE transmitted SL-RS and report the measurements to a second UE or to a Network entity.

According to another embodiment, the UE (it does not matter if it is a doer or coordinator) uses/receives a reference anchor time. Here, the UE performs one of the following steps:
receives a time reference information from a reference anchor
   the time reference is a forwarded time reference
      applies a range of sidelink information to determine either an absolute or common time, or
   the time reference is either based on a RS transmitted, received or transmitted and received from or to the Ref-Anchor
      report a measurement w.r.t to the Ref-Anchor time {Toa or Tx-RX where Rx is the time of reception of the Ref-Anchor} and/or perform a trigged transmission w.r.t to the Ref-Anchor time.

Note, the sidelink position reference signal (SL-PRS) is used as a discovery signal with different capabilities of positioning. According to an embodiment, the UE doer and/or coordinator has no communication link, but a ranging link. For example:
The SL-PRS can indicate:
   Ranging capability
      Including ranging modes
   A role (Doer or Coordinator) indication in the ranging process
   A response request according to a mode indicated by the specific SL-PRS
   Implicit mode selection by Doer when detecting several different modes (lowest common denominator).

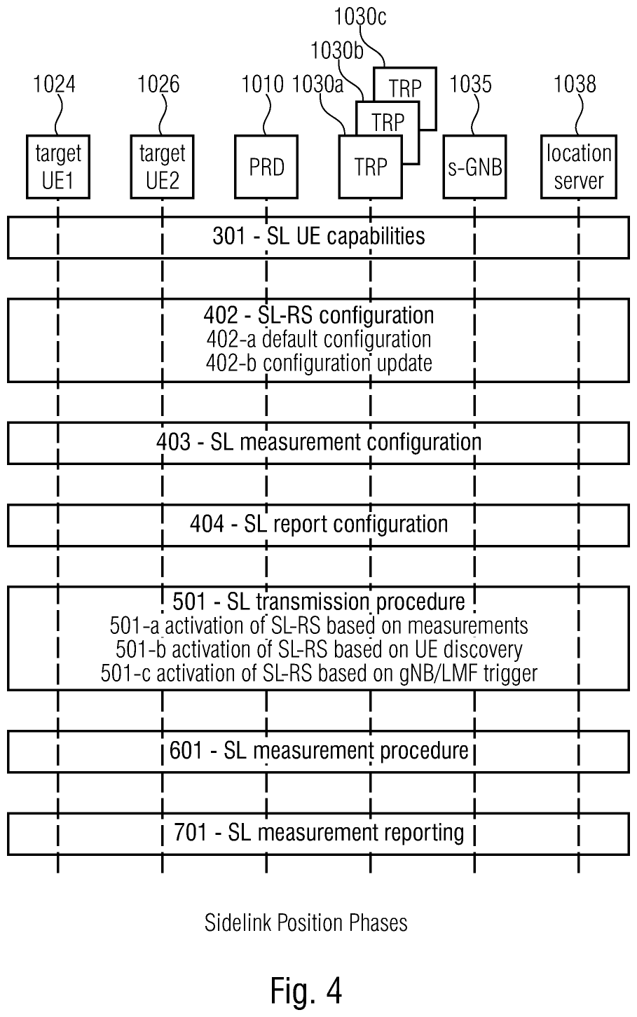

FIG. 4 illustrates the phases on the proposed framework for performing sidelink positioning. Here, seven phases are marked which are performed or collectively performed by the single entities. The first user equipment 1010 can be the coordinator and provides in this example a reference signal. Thus, the same is called reference. Additionally to the first user equipment 1010 further user equipments here target UEs 1024 and 1026 are marked.

These UEs 1024 and 1026 are comparable to second user equipment and referred to as target UEs. The background thereof is that the position of these UEs should be determined.

Additionally, the communication system comprises the optional elements TRP (transmission point) which are marked by the reference numeral 1030A, 1030B, 1030C. The number of the transmission points 1030A to 1030B is not limited, so all options from 0, 1-N are possible. It should further be noted, that the different transmission points 1030A-1030B, may belong to the same or to different communication providers. Additionally, a gMB 1035 as well as a localization server 1038 is provided. These two elements 1035 and 1038 communicate with the UEs 1010-1026 via the TRPs 1030A to 1030C. According to embodiments the coordinator may be formed by the gNB or the localization server 1038, in case the UE 1010 does not form the coordinator. An example for this is, when the UEs are in coverage. Below, the different phases will be discussed, wherein it should be noted, that not all entities 1010-1038 are involved. In detail, the procedure involves at least two devices, e.g. the UE 1024 and the positioning reference device PRD 1010. These are able to exchange at least one reference signal over the sidelink interface. The procedure performed by the one or more sidelink device 1010, 1024, 1026, may involve other entities, such as the serving S-gNB 1035, the TRPs 1030A-1030C and localization sever 1038 (or localization management function, LMF).

Furthermore, it should be noted that procedures include multiple phases, wherein the messages exchanged in configuration varies according to the operation modes (c.f. described above) and requested servers. The phase can be mandatory in some operation modes and optional or not needed for other operation modes.

During the first phase 301, transmission, measurement, reporting configurations are provided, e.g. based on a UE sidelink positioning capability, a request or a demand. This phase is called sidelink UE capability exchange phase

In one embodiment, the one or more sidelink devices informs an entity with capability information on the simultaneous transmission or reception of one or more SL resources or resource sets AND the transmission or/and reception of one or more UL or DL resources corresponding to one or more TRPs.

Additionally, the one or more sidelink devices informs an entity with capability information on the simultaneous transmission and reception of one or more SL resources or resource sets AND the transmission or/and reception of one or more UL or DL resources corresponding to one or more TRPs.

In one embodiment, the one or more sidelink devices informs an entity with capability information on the simultaneous transmission or/and reception of one or more SL resources or resource sets on a first frequency layer or bandwidth parts AND the transmission or/and reception of one or more SL resources on one more additional frequency layers or bandwidth parts.

In one embodiment, the one or more sidelink devices informs an entity with capability information on the coherent transmission or/and reception of one or more SL resources or resource sets on a first frequency layer or bandwidth parts AND the transmission or/and reception of one or more SL resources on one more additional frequency layers or bandwidth parts.

In one embodiment, the one or more sidelink devices informs an entity with capability information on the number of supported SL resource sets for sidelink positioning and the number of resource sets per bandwidth part (BWP).

In corresponding embodiment, the entity requesting or receiving the capability information may be an LMF, a serving gNB or a primary or/and secondary serving cell. Wherein the entity, or a second entity uses the capability indication(s) to configure the one or more sidelink devices. The second entity may be a serving-gNB configuring the SL device and not directly receiving or requesting the capability information. In out-of-coverage scenarios devices may request and receive capability information directly over sidelink without involvement of the aforementioned network entities.

The next phase 402 is referred to as sidelink UE resource configuration phase. Here a differentiation between a default configuration a configuration update (c.f. 402A and 402B) may be made.

In accordance with embodiments, the positioning sidelink configuration comprises at least one or more identifier(s), ID(s), of one or more SL-posRS resource(s) and/or SL-posRS resource set(s) to indicate at least one of the following parameters:
a spatial filter or beam direction for the transmission of one or more SL-posRS resource(s) and/or one or more ID(s), of one or more SL resource(s) and/or SL resource set(s) to indicate at least a spatial filter or beam direction for the reception of one or more SL resource(s).
List of SL Resources and SL-posRS Resource Sets to be added or removed
The number of SL resources per set for positioning
Triggering Types for the SL-posRS resources within a Set (Periodic, SP: Semi-Persistent, Aperiodic)
SL-posRS Power Control parameters including the Alpha and PO value as well as the reference signal used path loss determination. Note: The receive power level (RSSI and/or RSRP) and/or different interference levels and/or the transmitter bandwidth in SL-communication and/or SL-ranging/positioning may cause the effective SINR to be different at the two ends of a link involved in a ranging procedure. As a counter measure different SL-posRS Power Control parameters may be chosen for either end of the Sidelink.
   SL-posRSPower Parameters can be chosen wrt:
      Sidelink direction
      Individual or groups of SL pairs
      For a group of UEs involved in a P2MP, MP2P or MP2MP ranging/positioning procedure.
   Furthermore, the allocated SL-posRS Power Control parameters can be chosen according to a measurement/estimation result from a previous, recent or initial coarse ranging measurement OR based on available side information about the actual locations of the devices involved in the ranging/positioning process.
SL-posRS Timing Information, including:
   Timing advance indication
   SL-posRS resource periodicity per Resource Set. Wherein all the SL-posRS resources within one SL-posRS resource set are configured with the same resource periodicity.
   Semi-persistent scheduling define transmission of an SL-posRS over a certain period over a defined interval.
   OFDM symbol Offset or slot Offset with respect to the SFN=0.

The SL-posRS resources and resource set configurations are provided to the one or more sidelink devices on a higher layer interface such as LPP from the LMF or possibly from a serving cell over an RRC or MAC-CE or DCI interface or SDT interface in inactive state. Note the current LPP is between a single UE and the network. If one considers a swarm of UEs in OOC which could support themselves to do positioning, a newly designed protocols between UEs can be used. This enables all the positioning configuration and reporting exchange (e.g. only between theses UEs) enabling positioning between UEs only (where no network is involved). The new protocol could be given a name like SLPP (sidelink positioning protocol).

In accordance with embodiments, the sidelink device may receive a message indicating the one or more resource(s) or/and resource set(s) are applicable when the sidelink device is in out of coverage scenario. The UE may receive a validity information which can be a timer or a geographical area such as (zone cell, TAI) where the configuration is valid.

Similarly, the sidelink device may receive a message indicating the one or more resource(s) or/and resource set(s) are applicable when the sidelink device is idle or inactive state. This can enable the sidelink device to perform sidelink procedure independent of the communication state with the serving cell or LMF.

Within the phase 403, the one or more sidelink devices may, according to embodiments, be configured for the measurement. Therefore, the phase is called sidelink UE measurement configuration phase. According to embodiments, a network entity may provide or update the one or more sidelink devices or the reference device with SL-posRS measurement configuration which are indicated as IEs (Information Elements) over a higher layer interface like LPP for the case the configuration entity being an LMF or one of the following RRC, MAC-CE, DCI or SCI for the case the configuration entity being a gNB or PC5 (Sidelink) interface for the case the configuration entity being a second sidelink device.

The sidelink device may receive a high layer configuration message which includes assistance information on the SL-posRS resources the sidelink is expected to perform measurements on from one or more other SL devices.

During the sidelink transmission procedure phase 501, differentiation may be made between activation of sidelink RS based on measurement (501A), activation of SL-RS based on UE discovery (501B) and activate of SL-RS based on gNB/LMF (501C). Here the main steps are one of the following:
Receive of configuration on SLposRS configuration to transmit,
Receive on indication for a triggered or scheduled transmission.

Further examples for exchanging/triggering steps of the D2D positioning/ranging have been discussed above.

The next phase 601 is the sidelink measurement procedure phase. Here one of the following steps may be performed:
Receive a system data including SLposRS configuration to measure,
Type of measurements depend on the method, like RSRP, ToA, range, relative orientation.

Details regarding the measurement have been discussed above, e.g. in context of FIG. 3.

In the next phase 702 (called sidelink-reporting phase) the reports for the measurements or information regarding the measurements are exchanged.

The SL-device, measuring one or more SL-posRS resources or resource sets may report multiple measurement instances of (ToA, SL RSRP, SL-AoA, SL-AOD, range, and/or SL Rx-Tx time difference measurements) in a single measurement report to the network node for SL-assisted positioning. The measurement report may include timestamp on the one or more measurements within the same measurement report.

The SL-device may report multiple measurement instances in a single measurement report to the network node. A measurement instance may include measurement information from one or more measurement occasion which may be obtained by averaging over multiple occasions. A measurement instance may also refer to one or more measurements of the same or different types, which are obtained from the same SL-posRS resources or resource set. The measurement device may report the one or measurement instances with one or more timestamps. In one example, two measurement results reported with the same timestamp for the same SL-RS measurement may correspond to different reception characteristics at the measuring SL-device.

In one aspect, the SL-device may be configured to derive the timing reference for a measurement report one or more measurement instances of the DL-RS/UL-RS. The timing reference configuration may include an indication to a SFN value, SFN offset w.r.t to a reference signal, slot boundary, slot offset.

In one aspect, the SL-device may be configured to one or more SL positioning measurements and DL or UL-DL positioning measurements. The SL device may include the measurements in the same measurement report.

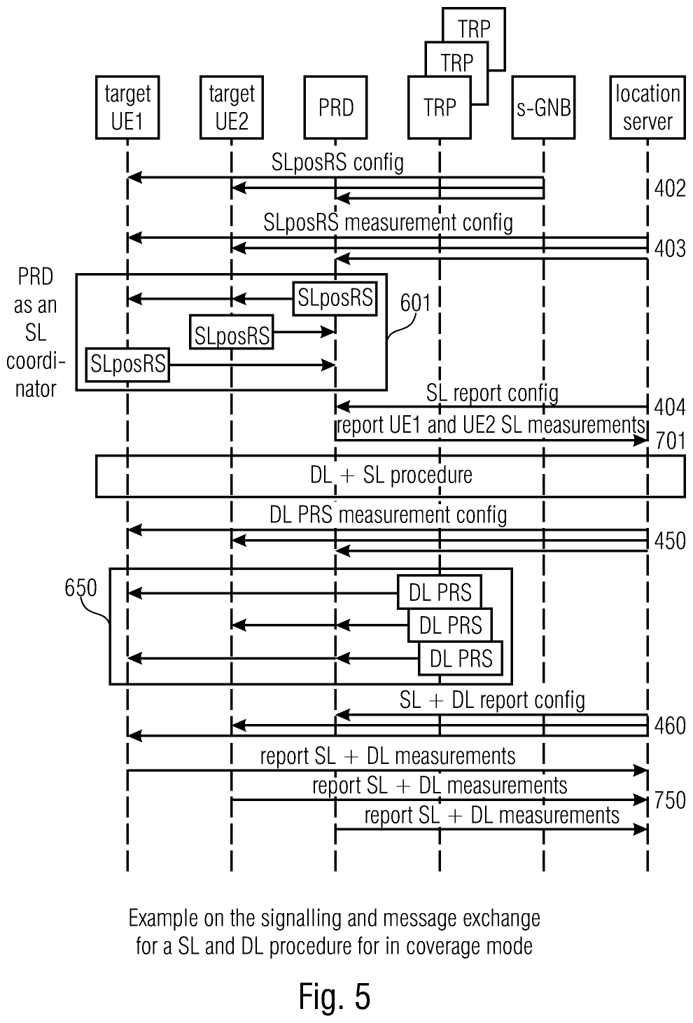

With respect to FIG. 5 an example for sidelink operation between the sidelink devices 1010, 1024, 1026, 1030A, 1030B, 1030C, 1035 and 1038 is given. The device 1010, 1024, 1026 receives a configuration message including SLposRS configuration for the transmission of the one or more SLpos resources. It is not mandatory that every sidelink device transmits a SLposRS, in some examples one or more SL devices can be configured to only perform measurements on SLposRS.
The Devices 1010, 1026 and 1024 receives a measurement configuration for the measurement of the SLposRSs from a network entity such as the LMF
The transmission, measurement and reporting are set based on the method, operation mode and Coordinator/Doer configuration. In this example, the Positioning reference device is set as a coordinator which is can be able to extract range information directly based on the information from the received reference signals. The PRD 1010 may receive directly or indirectly (via the network) additional information on the measurements or the transmission times of UE1 and UE2.
The SL procedure can be combined with the other UL/DL or UL-and-DL positioning methods as shown in the message exchange and signalling of FIG. 5.

The schematic diagram of FIG. 5 illustrates the different exchange communication signals. The signals are exchanged between the different entities 1010, 1024, 1026, 1030, 1035 and 1038. The arrows between the different entities disclose which message belonging to which phase (c.f. phases 301, 402, 403, 404, 501, 601 and 701) the messages are exchanged. The measurement procedure may have different directions for the signal exchange according to different embodiments. For example, just the PRD 1010 may perform the measurement, e.g. using two-way ranging or the target UEs 1024 and 1026 to transmit a reference signal to the PRD 1010 (one-way ranging). Furthermore, it is also possible, that according to an embodiment the reference device 1010 transmits a reference signal, wherein the measurement is performed by the target UEs 1024 and 1026.

Alternatively or additionally to the sidelink measurement procedure 602, the concept may be enhanced by uplink/downlink measurements which is marked by the reference numeral 650. Here for example, the transmission points 1030A, 1030B, 1030C for which typically the position is known can transmit a reference signal, so that the same reference signal can be determined by the entities 1010, 1024 and 1026, so that the same entities can perform measurement, e.g. one-way ranging including time anchor.

The exchange of the communication for the downlink/uplink measurement is part of the phase 301, 402, 403 and 404, but enhanced to the downlink/uplink measurement capabilities. In this case, additional configuration signals are exchanged during the phases 405 (downlink/uplink measurement configuration), 406 (downlink/uplink report configuration) and 750 reporting on downlink/uplink measurements.

It should be noted, that FIG. 5 does not show the messages exchanged during the phase 301.

The triggering of a so-called triggered beacon may be implemented according to embodiments. This may be realized using UEs equipped with a wakeup receiver (based on a specific code), which may be configured for:

Two-stages: wakeup followed by synchronization or including synchronization
Correlating using a certain sequence to identify the intended receiver
Decoding a message, triggering the transmission of a beacon (synchronized or unsynchronized to an external or internal sync signal)
Transmitting a beacon information containing at least one of:
synchronized time reference and/or position
beacon device specific identifier (ID) to make the origin of the beacon identifiable
location specific identifier (ID) to make the location identifiable
content specific identifier (ID) to make an event identifiable
condition specific identifier (ID) to make a condition identifiable at a particular location or region/area
state specific identifier (ID) to make a state identifiable of a particular object, location, area
event specific identifier (ID) to make an event identifiable of a particular object, location, area.

Enhancement triggers may originate from different base stations (distributed in space). Therefore, changing the order of the beacon transmitters (BTXs) in time can average out near-far effects between BTS and BTX.

Note the base station (or a “lead UE”) could be used to trigger and orchestrate sidelink-assisted position/location estimation procedures.

Below the concept of a time anchor will be discussed:

A timing reference point that is known to all devices is termed a “time anchor” or a reference anchor—for example a TRP, gNB, UE. Note, device as a device which transmit or receive or transmit and receive from two or more other devices can form a reference device. The Tx or Rx time w.r.t this reference device is the reference point, i.e. a time anchor.

With respect to the time anchor/reference anchor, a device determines the round-trip-time (two-way ranging). This is the time from the device to the time anchor/reference anchor and then from the time anchor/reference anchor back to the device.

In particular in partial-OOC scenarios, e.g. devices which want to perform ranging/positioning tasks deep-indoors, wherein at least one device is in coverage of a time anchor/reference anchor while others may be OOC with to the time anchor/reference anchor but within communication range of the at least one UE in coverage wherein communication range may include direct communication or communication over a relay.

In such scenario, the time anchor/reference anchor can be propagated/forwarded from the UE within coverage to e.g. a gNB and used by other UEs as a reference in a joint ranging/positioning task to be performed.

Furthermore, propagation of time anchor/reference anchor and geo-location RA from several devices sufficiently/suitably distributed in space allows to obtain an absolute positioning anchoring even for distributed devices deep-indoors via propagation of timing and geo-location reference anchors.

Note the two-way ranging can be initiated in both directions.

UE-centric: A device (UE) is requesting the time anchor device to:
a.) respond to a RTT measurement signal and transmit a response message and the UE can calculate RTT with knowledge of the internal delay between the received signal at reference anchor and the transmitted signal from the reference anchor
b.) Transmit a RTT measurement signal to the UE and expect and receive a response transmit signal from the UE, and calculate the RTT and communicate to the UE. For example, a measurement configuration for the RTT process can be initiated by the reference anchor or is known a priori based on a previous or default configuration.

Reference anchor centric: reference anchor initiates an RTT measurement similar to above. Main difference of this embodiment is who is initially triggering such RTT measurement.

In other word this means the “time anchor” is used in this disclosure as a time anchor global for more than one UE (a group or all UEs) which allows, for example, one way ranging, when SL-PRS are transmitted.

Nevertheless or furthermore, the indication or providing an offset to e.g. a local time reference in one device would be helpful and sufficient for a positioning or ranging task to be performed. Therefore, the time anchor can be a kind of relative time anchor having a reference or offset to a local time reference.

As an example: A responding device has its internal time base and reports the following:
a.) reception of an incoming signal at time A relative to an internal frame start
b.) transmission of an outgoing signal at time B relative to the same internal frame start

According to embodiments the time anchor can be a “global” time anchor or a time anchor available in “all” UEs or a relative or local time anchor.

Embodiments provide different scenarios. According to scenario 1 a network anchor, e.g. transmitted using a DL (c.f. step 650 of FIG. 4) maybe used.

### Scenario 1—NW Anchor Assisted SL Determination:

The anchor sends a DL signal which is received by UE1 and UE2
The anchor receives a reply from UE1 and UE2 (compute the range between the UE and the anchor)
The anchor determines a range and the time difference between UE1 and UE2
Either UE1 or UE2 sends a SL signal and the other receives and reports the ToA measurement
The anchor applies for example the time correction on the ToA SL measurement and computes the range
NOTE: the clock offset between the anchor and the UEs may be ignored

The advantage is that one way signalling is sufficient.

According to scenario 2, an entity, e.g. LMF may use a SL measurement and corrects this signal.

### Scenario2 NW SL Assisted Positioning:

The UEs performs SL ranging
The NW makes use of the SL range to correct an TDOA or RTT measurement for both UEs with the Anchor

This leads to the advantage of enhanced NW based accuracy with SL information. The assumption is that the SL range is more accurate than a TDOA/RTT measurement.

Note, ideas for creating a time anchor are not limited to include the following two examples of “hyper-bandwidth”:
Take two spectrum chunks where BW1 spans f1 to f2 and BW2 spans f3 to f4. There is a gap between f2 and f3. The combination of BW1 and BW2 improves overall resolution but increases ambiguity due to the gap (f2 to f3). (This is possible in Rel-16 by configuring two or more bandwidth parts (up-to 4) within the active BWP)
Take two spectrum chunks where BW1 spans f1 to f2 and BW2 spans f1+fd to f2+fd. fd is a small difference in frequency (half a step or half a sample). Combine BW1 and BW2 in the way that is done for ADCs.

According to embodiments, the following use cases are possible:
Simplest use case first. For example, line-of-sight (LOS) and stationary (non-moving) positions.
Add increasingly complex impairments to the simplest case—for example non-LOS, mobile.
Focus on “good enough” time reference (e.g. a basestation) first. Consider more accurate timing reference signals in a later stage.

Below, embodiments of the present invention having focus to the communication system will be discussed. These embodiments enhance the above discussed embodiments.

According to an embodiment, the first and/or the second user device is configured to forward an information on an anchor, time anchor or reference anchor via the sidelink; and/or wherein the forwarding is initiated by the coordinator; and/or wherein an information on the anchor, or reference anchor is comprised by a measurement configuration information.

According to an embodiment, the measurement resource configuration information comprises at least one of the following parameters:
a spatial filter or beam direction for the transmission of one or more sidelink resource(s) and/or one or more ID(s) of the one or more sidelink resource(s);
spatial filer direction including an indication of an identifier for a UL SRS, or a DL RS resources (PRS, CSI-RS or SSB) (so that a user device is enabled to apply an indication of spatial filer direction to a transmission or receipt of an indicated resources);
spatial filer direction includes an indication of an identifier for a SL-RS resource (so that a user device is enabled to apply an indication of spatial filer direction to a transmission or receipt of an indicated resources);
list of sidelink resources to be added or removed;
number of sidelink resources per set for positioning;
triggering types for the sidelink resources (e.g. Periodic, SP: Semi-Persistent, Aperiodic);
sidelink resource power control parameters;
sidelink timing information;
resources to be used for an out of coverage scenario.

According to an embodiment, the measurement configuration information comprises at least one of the following parameters:
information on anchor, a time anchor or reference anchor;
information on a reference signal; and/or

wherein the measurement configuration information is received over a higher layer interface and/or from a localization server (RRC, MAC-CE, DCI for the case the configuration entity being a gNB or PC5 (Sidelink) interface for the case the configuration entity being a second sidelink device).

According to an embodiment, the communication system further comprises a third user device or a third user device used as doer or a plurality of further user devices or a plurality of further devices used as doers.

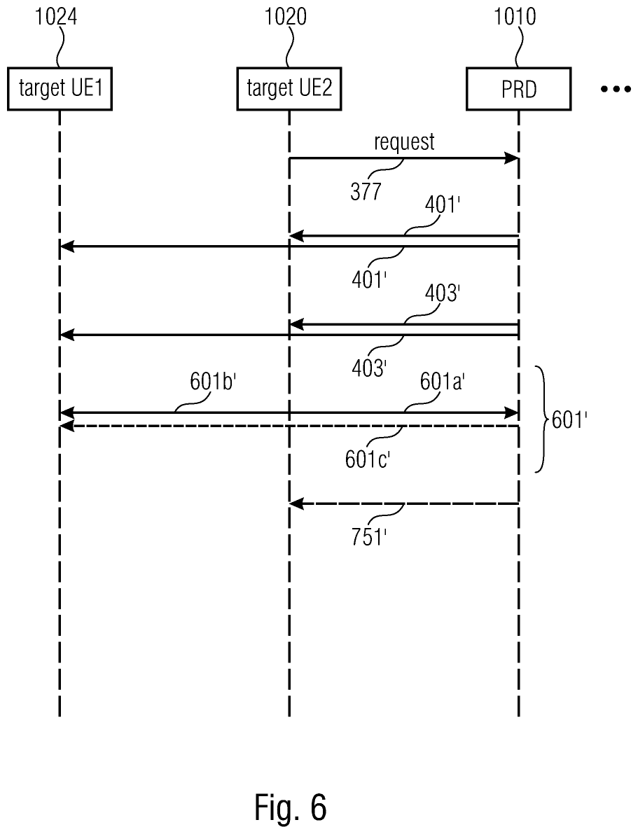

FIG. 6 shows a comparable diagram to FIG. 5 illustrating the exchange of the information regarding a measurement configuration or a measurement resource configuration. Here, the three UEs 1010, 1020 and 1024 are illustrated, wherein the UE 1010 acts as coordinators, while the UEs 1020 and 1024 as doers. This situation can be a partially out of coverage situation (e.g. 1010 in coverage, while the other UEs is out of coverage) or an out of coverage situation, but also an in-coverage situation, wherein the further entities are not illustrated or used.

This embodiment starts from an assumption that the UE 1020 has the demand to determine its position, e.g. the relative position to the entities 1010 and 1024 or the absolute position. In such a case, the UE 1020 sends a request to the coordinator 1010 as illustrated by the arrow 377. Generally speaking, this means that a doer UE, here the UE 1020 is configured to request a device-to-device positioning or ranging procedure. The coordinator 1010 is configured to receive this request 377 and to coordinate the device-to-device positioning or arranging on demand. For example, it determines itself and the UE 1024 as UEs surrounding the UE 1020, so that same can be used for participating at the device-to-device positioning or arranging. For the device-to-device positioning or arranging procedure, the coordinator 1010 provides the information regarding the measurement (cf. formula 2′) and the information regarding the measurement resources (cf. 403′). Also other UEs within the network may sent a request 377.

According to embodiments, the measurement is mainly performed by the UE 1020. For example, in the phase 601′, the UE 1020 performs a measurement 601a′ with respect to the device 1010, e.g., a two-way arranging, where for example the delay time is known due to the measurement configuration 402′ (and a measurement 601b′ between the UE 1020 and 1024). As a result of these two measurements 601a′ and 601b′, a relative position of the UE 1020′ can be determined. If, for example, one UE, for example the PRD (reference UE) 1010 has none absolute position, the position of the UE 1020 can be determined more accordingly. In order to further improve the measurement preciseness, arranging between the UE 1010 and the UE 1024 may be performed as illustrated by the step 601c′. This measurement is, for example, performed by the UE 1010, wherein the measurement result is reported to the UE 1020 as illustrated by the step 751′. This procedure has the benefit that the only UE which can determine the position to be determined is the UE 1020, since same is the only UE having access to the measurement results.

It should be noted that the measurement 601c′ may be performed differently, e.g. a round trip delay of a reference signal transmitted by the entity 1010 to the entity 1020 via the entity 1024 (forwarding entity) can be used. In general, all the embodiments have a coordinator 1010 that coordinates the measurement, while single measurement steps are performed by several entities 1010, 1020, 1024 within the network.

According to embodiments, the first user device 1010, e.g. having the sidelink-positioning demand is configured to determine the sidelink-positioning demand and/or to initiate (request) the device-to-device positioning or ranging in response to said sidelink-positioning demand. Thus, the coordinator can initiate a sidelink positioning procedure by itself. This demand may be a factor to select UE 1010 as coordinator

According to embodiments, the second user equipment 1020 has the demand and is configured to transmit the sidelink-positioning request 377 to the first user device 1010; and/or wherein the first user device is configured to receive the sidelink-positioning request and/or to initiate the device-to-device positioning or ranging in response to said sidelink-positioning request. Thus, a coordinator coordinates the sidelink positioning procedure if a UE wants to initiate SL-ranging.

In other words this means that the coordinator is configured
to receive a sidelink-positioning request OR
to determine a sidelink-positioning demand OR
to initiate/request a sidelink-positioning

AND
to coordinate the device-to-device positioning or ranging
   in response to said request OR
   in response to said sidelink-positioning demand OR
   in response to said initiate/request of sidelink-positioning.

According to an embodiment, the device-to-device positioning or ranging is enhanced by an uplink measurement and/or a downlink measurement; and/or wherein the measurement configuration information comprise information on uplink resources to be used for uplink measurement and/or on a downlink resources to be used as downlink measurement; and/or wherein the uplink measurement and/or a downlink measurement is performed in collaboration to a transmission point serving as reference anchor.

According to an embodiment, the first and/or second user device communication using the sidelink provides a measurement report or an information with respect to time of transmission of an UL-SRS on Uu or a measurement report comprising one of the following information:
time difference (UL_SRS_Tx, SL_PRS_Tx) or time difference between the transmission of an SRS and the transmission of a SL-PRS;
time difference (UL_SRS_Tx, SL_PRS_Rx) or time difference between the transmission of an SRS and the reception of a SL-PRS; and/or

wherein the first and/or second user device communication using the sidelink provides a measurement report or an information with respect to time of reception of a DL-PRS on Uu or measurement report comprising one of the following information:
time difference (DL-PRS_Tx, SL_PRS_Tx) or time difference btw the reception of a PRS and the transmission of a SL-PRS;
time difference (DL_PRS_Tx, SL_PRS_Rx) or time difference btw the reception of a PRS and the reception of a SL-PRS.

According to an embodiment, the first and/or the second user device are configured to generate a report on the sidelink measurement, uplink measurement and/or downlink measurement to be forwarded to a localization server; and/or wherein the report is generated and transmitted by the first user device as coordinator or wherein the report is generated and transmitted by the second user device as doer and initiated by the coordinator; and/or wherein the report comprises information one or more measurement instances or on one or more measurement instances with one or more timestamps and/or an indication or offset information of the timestamps with respect to a time anchor.

According to an embodiment, the user device out of a plurality of user devices is selected as first user device as coordinator based on one of the following criteria:
requirement of the UE for a measurement or position determination;
request by a localization server;
a pre-configuration;
a capability of the user device a UU capability of the user device, a sidelink capability of the user device;
a position of the user device within the network;
a reachability of the user device within the network or a reachability of the user device within the network via sidelink.

According to an embodiment, the coordinator is configured to receive measurement resource configuration information from the gNB and/or to receive measurement configuration information from a localization server.

According to an embodiment, the device-to-device positioning or ranging comprises the determination of the position based on measurements, wherein the determination is performed by the localization server, or by the first user device or by the coordinator or by the second user device as doer.

According to an embodiment, the eNB or the localization sever is configured to coordinate as coordinator or to provide measurement resource configuration information or to provide measurement configuration information.

According to an embodiment, the eNB or the localization server coordinates or provides measurement resource configuration information or to provide measurement configuration information if the first user device and the second user device are in coverage or if the first user device and the second user device are partially out of coverage, so that at least the first user device acting as coordinator is in coverage.

According to an embodiment, the coordination is based on a preconfigured default setting defining measurement resource information and/or defining measurement configuration information; or wherein the coordination performed by to coordinator is based on preconfigured default settings defining measurement resource configuration information and/or measurement configuration information, if the first and the second user device are out of coverage and/or if the first and the second user device are partially out of coverage.

According to an embodiment, an additional coordinator; and/or further comprising another network entity, an eNB and/or a localization server (manager).

According to an embodiment, the coordinator is configured to exchange information with other communication system entities dependent on a communication mode, which is defined by the presence of other entities of the communication system, wherein the other entities are of different types.

According to an embodiment, the first and the second user device are configured to inform on capability with respect to coherent or simultaneous transmission and/or receipt and/or with respect to transmission and/or receipt of one or more uplink or downlink resources and/or with respect to a member of supported sidelink resource sets for sidelink positioning; and/or wherein the first and the second user device are configured to inform on capability, for the first and/or the second user device for simultaneous transmission and/or reception on the sidelink PRS and/or UL-SRS transmission and/or DL-PRS reception; and/or wherein the first and the second user device are configured to inform on ranging capability, on capability including ranging modes, on a role (Doer or Coordinator) indication in the ranging process, on a response request according to a mode, or on an implicit mode selection by the doer when detecting several different modes.

Further embodiments may be implemented as a user device, e.g. first user device and/or second user device.

According to an embodiment, there is provided a user device forming a first or a second user device of a communication system comprising at least the first and the second user device, wherein the first and the second user devices are configured to use a sidelink for a sidelink communication; wherein the first and the second user devices are configured to commonly perform device-to-device positioning or ranging while exchanging signals via the sidelink; wherein the communication system further comprises a coordinator; the coordinator configured to receive a sidelink-positioning request or to determine a sidelink-positioning demand and, in response to said request or depending or to said sidelink-positioning demand, the coordinator is configured to coordinate the device-to-device positioning or ranging.

According to an embodiment, the first user device comprises the coordinator.

According to an embodiment, the second user device is a doer configured to perform one or more parts of the device-to-device positioning or ranging; and/or wherein the second user device is a doer configured to perform as part of the device-to-device positioning or ranging a measurement, or to provide a reference signal or to provide a reference anchor, or to forward a sidelink reference anchor, or to forward a configuration information, to forward a measurement resource configuration information, to forward a measurement configuration information or to provide a report on the device-to-device positioning or ranging or on a measurement of the device-to-device positioning or ranging.

According to an embodiment, the coordinator is configured to control the second user device with respect to the device-to-device positioning or ranging by use of a measurement resource configuration information and/or by use of a measurement configuration information; and/or wherein the coordinator is configured to inform the second user device on one or more of the following information:
Sidelink positioning resource configuration;
measurement configuration;
report configuration;
transmission procedure;
measurement protocol;
measurement report.

Alternatively, a pre-configuration can be used. According to an embodiment, the coordinator is configured to coordinate the device-to-device positioning or ranging based on already known sidelink positioning resource configuration and/or measurement configuration and/or by starting the device-to-device positioning or ranging, e.g. without prior configuration of the other device. For example, the coordinator is configured to coordinate the device-to-device positioning or ranging by providing a transmit signal as a reference point or transmitting a transmit signal as a reference point to preconfigured user devices (without any need to configure anything).

According to an embodiment, the coordinator is configured to determine a position information for the second user device, or to collect measurements for the second user device or for another doer; and/or to trigger a transmission, to trigger a transmission of a reference signal, to forward a reference signal, to trigger a measurement event to be performed by the second user device or another doer or to trigger the second user device or another doer; and/or to provide a report on the device-to-device positioning or ranging or on a measurement of the device-to-device positioning or ranging.

According to an embodiment, the coordinator is configured to support or assist the device-to-device positioning or ranging to determine a position information for the second user device, or to collect measurements for the second user device or for another doer. According to an embodiment, the coordinator is configured to respond on a received signal with a transmission or to respond on a received signal with a transmission of a reference signal, or to perform and/or assist a measurement for the second user device or another doer or to respond to a received trigger signal by the second user device or by another doer. According to an embodiment, the coordinator is configured to provide a report on the device-to-device positioning or ranging or on a measurement of the device-to-device positioning or ranging.

According to an embodiment, the device-to-device positioning or ranging comprising a sidelink measurement; and/or wherein the device-to-device positioning or ranging comprises a sidelink measurement performed by the first or the second user device, wherein the sidelink measurement comprise at least one of the groups comprising:
two-way ranging or two-way ranging using a reference signal;
one way ranging with time anchor or one way ranging with time anchor using a reference signal;
one way ranging with signal strength anchor or one way ranging with signal strength anchor using a reference signal;
one way ranging based on RSSI path loss estimation or one way ranging based on RSSI path loss estimation using a reverence signal;
one-way or two-way ranging based on time-of-flight determination;
determining an angle of arrival and/or angle of departure;
determining a relative position or distance between the first and the second user device and/or determining an absolute position of the first or second user device or to determine a position of an anchor or of a reference point by use of one-way or two-way ranging;
determining a relative position or distance between the first and the second user device without time anchor, without reference anchor and/or an absence of line of sight between the first and the second user device and/or in the presence of ling of sight between the first and second user device by use of one-way or two-way ranging;
determining a relative position of the first user device with respect to another entity of the communication system or determining a relative position of the second user device with respect to another entity of the communication system; or
determining an absolute position by use of an anchor, or reference anchor, wherein an information on the anchor, or reference anchor is comprised by a measurement configuration information.

According to an embodiment, the first and/or the second user device is configured to forward an information on an anchor, time anchor or reference anchor via the sidelink; and/or wherein the forwarding is initiated by the coordinator; and/or wherein an information on the anchor, or reference anchor is comprised by a measurement configuration information.

According to an embodiment, the measurement resource configuration information comprises at least one of the following parameters:
a spatial filter or beam direction for the transmission of one or more sidelink resource(s) and/or one or more ID(s) of the one or more sidelink resource(s);
spatial filer direction including an indication of an identifier for a UL SRS, or a DL RS resources (PRS, CSI-RS or SSB) (so that a user device is enabled to apply an indication of spatial filer direction to a transmission or receipt of an indicated resources);
spatial filer direction includes an indication of an identifier for a SL-RS resource (so that a user device is enabled to apply an indication of spatial filer direction to a transmission or receipt of an indicated resources);
list of sidelink resources to be added or removed;
number of sidelink resources per set for positioning;
triggering types for the sidelink resources (e.g. Periodic, SP: Semi-Persistent, Aperiodic);
sidelink resource power control parameters;
sidelink timing information;
resources to be used for an out of coverage scenario.

According to an embodiment, the measurement configuration information comprises at least one of the following parameters:
information on anchor, a time anchor or reference anchor;
information on a reference signal; and/or

wherein the measurement configuration information is received over a higher layer interface and/or from a localization server (RRC, MAC-CE, DCI for the case the configuration entity being a gNB or PC5 (Sidelink) interface for the case the configuration entity being a second sidelink device).

According to an embodiment, the device-to-device positioning or ranging is enhanced by an uplink measurement and/or a downlink measurement; and/or wherein the measurement configuration information comprise information on uplink resources to be used for uplink measurement and/or on a downlink resources to be used as downlink measurement; and/or wherein the uplink measurement and/or a downlink measurement is performed in collaboration to a transmission point serving as reference anchor.

According to an embodiment, the first and/or second user device communication using the sidelink provides a measurement report or an information with respect to time of transmission of an UL-SRS on Uu or a measurement report comprising one of the following information:
time difference (UL_SRS_Tx, SL_PRS_Tx) or time difference between the transmission of an SRS and the transmission of a SL-PRS;
time difference (UL_SRS_Tx, SL_PRS_Rx) or time difference between the transmission of an SRS and the reception of a SL-PRS; and/or

wherein the first and/or second user device communication using the sidelink provides a measurement report or an information with respect to time of reception of a DL-PRS on Uu or measurement report comprising one of the following information:
time difference (DL-PRS_Tx, SL_PRS_Tx) or time difference btw the reception of a PRS and the transmission of a SL-PRS;
time difference (DL_PRS_Tx, SL_PRS_Rx) or time difference btw the reception of a PRS and the reception of a SL-PRS.

According to an embodiment, the first and/or the second user device are configured to generate a report on the sidelink measurement, uplink measurement and/or downlink measurement to be forwarded to a localization server (manager); and/or wherein the report is generated and transmitted by the first user device as coordinator or wherein the report is generated and transmitted by the second user device as doer and initiated by the coordinator; and/or wherein the report comprises information one or more measurement instances or on one or more measurement instances with one or more timestamps and/or an indication or offset information of the timestamps with respect to a time anchor.

According to an embodiment, the user device out of a plurality of user devices is selected as first user device as coordinator based on one of the following criteria:
requirement of the UE for a measurement or position determination;
request by a localization server;
a pre-configuration;
a capability of the user device a UU capability of the user device, a sidelink capability of the user device;
a position of the user device within the network;
a reachability of the user device within the network or a reachability of the user device within the network via sidelink.

According to an embodiment, the coordinator is configured to receive measurement resource configuration information from the gNB and/or to receive measurement configuration information from a localization server.

According to an embodiment, the device-to-device positioning or ranging comprises the determination of the position based on measurements, wherein the determination is performed by the localization server, or by the first user device or by the coordinator or by the second user device as doer.

According to an embodiment, the coordination is based on a preconfigured default setting defining measurement resource information and/or defining measurement configuration information; or wherein the coordination performed by to coordinator is based on preconfigured default settings defining measurement resource configuration information and/or measurement configuration information, if the first and the second user device are out of coverage and/or if the first and the second user device are partially out of coverage.

According to an embodiment, the coordinator is configured to exchange information with other communication system entities dependent on a communication mode, which is defined by the presence of other entities of the communication system, wherein the other entities are of different types.

According to an embodiment, the first and the second user device are configured to inform on capability with respect to coherent or simultaneous transmission and/or receipt and/or with respect to transmission and/or receipt of one or more uplink or downlink resources and/or with respect to a member of supported sidelink resource sets for sidelink positioning; and/or wherein the first and the second user device are configured to inform on capability, for the first and/or the second user device for simultaneous transmission and/or reception on the sidelink PRS and/or UL-SRS transmission and/or DL-PRS reception; and/or wherein the first and the second user device are configured to inform on ranging capability, on capability including ranging modes, on a role (Doer or Coordinator) indication in the ranging process, on a response request according to a mode, or on an implicit mode selection by the doer when detecting several different modes.

According to an embodiment, the first or the second user device comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader (GL) UE, or an IoT or narrowband IoT, NB-IOT, device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IOT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a base station comprises one or more of the following: a macro cell base station, or a small cell base station, or a central unit of a base station, or a distributed unit of a base station, or a road side unit (RSU), or a UE, or a group leader (GL), e.g. a GL-UE, or a relay or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

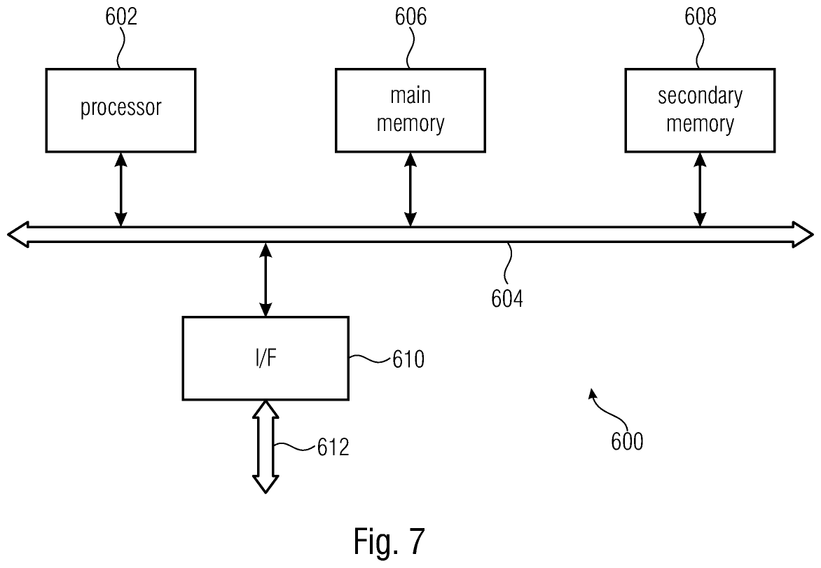

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 7 illustrates an example of a computer system 800. The units or modules as well as the steps of the methods performed by these units may execute on one or more computer systems 800. The computer system 800 includes one or more processors 802, like a special purpose or a general-purpose digital signal processor. The processor 802 is connected to a communication infrastructure 804, like a bus or a network. The computer system 800 includes a main memory 806, e.g., a random-access memory, RAM, and a secondary memory 808, e.g., a hard disk drive and/or a removable storage drive. The secondary memory 808 may allow computer programs or other instructions to be loaded into the computer system 800. The computer system 800 may further include a communications interface 810 to allow software and data to be transferred between computer system 800 and external devices. The communication may be in the from electronic, electromagnetic, optical, or other signals capable of being handled by a communications interface. The communication may use a wire or a cable, fibre optics, a phone line, a cellular phone link, an RF link and other communications channels 812.

The terms “computer program medium” and “computer readable medium” are used to generally refer to tangible storage media such as removable storage units or a hard disk installed in a hard disk drive. These computer program products are means for providing software to the computer system 800. The computer programs, also referred to as computer control logic, are stored in main memory 806 and/or secondary memory 808. Computer programs may also be received via the communications interface 810. The computer program, when executed, enables the computer system 800 to implement the present invention. In particular, the computer program, when executed, enables processor 802 to implement the processes of the present invention, such as any of the methods described herein. Accordingly, such a computer program may represent a controller of the computer system 800. Where the disclosure is implemented using software, the software may be stored in a computer program product and loaded into computer system 800 using a removable storage drive, an interface, like communications interface 810.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[DW1000] public datasheets of DW1000 available, including an explanation of two-way-ranging including multiple measurements, e.g. for delay calibration and double-sided two-way-ranging.
[1] 3GPP TR 21.905: “Vocabulary for 3GPP Specifications”.
[2] 3GPP RP-201518: “Revised SID on Study on scenarios and requirements of in-coverage, partial coverage, and out-of-coverage positioning use cases”.
[3] 3GPP TS 22.261: “Service requirements for the 5G system”.
[4] 3GPP TS 22.186: “Enhancement of 3GPP support for V2X scenarios”.
[5] 3GPP RP-210040: “Reply LS to RP-201390 on requirements of in-coverage, partial coverage, and out-of-coverage positioning use cases,” (source: 5GAA).
[6] 3GPP RP-210036: “Reply LS to 3GPP TSG RAN on requirements of in-coverage, partial coverage and out-of-coverage positioning use cases,” (source: SAE Advanced Applications Technical Committee)
[7] 3GPP TS 22.280: “Mission Critical Services Common Requirements (MCCoRe)

### ABBREVIATIONS

2G second generation
3G third generation
3GPP third generation partnership project
4G fourth generation
5G fifth generation
5GC 5G core network
ACLR adjacent channel leakage ratio
AP access point
ARQ
BER
automatic repeat request
bit-error rate
block-error rate
BLER
BS basestation transceiver
BT Bluetooth
BTS basestation transceiver
CA carrier aggregation
CBR channel busy ratio
CC component carrier
CCO coverage and capacity optimization
CHO conditional handover
CL cross-link interference
CLI-RSS cross-link interference received signal strength
CP1 control plane 1
CP2 control plane 2
CSI-RS channel state information reference signal
CU central unit
D2D device-to-device
DAPS dual active protocol stack
DC-CA dual-connectivity carrier aggregation
DECT digitally enhanced cordless telephony
DL downlink
DMRS demodulation reference signal
DOA direction of arrival
DRB data radio bearer
DU distributed unit
ECGI E-UTRAN cell global identifier
E-CID enhanced cell ID
eNB evolved node b
EN-DCE-UTRAN-New Radio dual connectivity
EUTRA Enhanced UTRA
E-UTRAN Enhanced UTRA network
gNB next generation node-b
GNSS global navigation satellite system
GPS global positioning system
HARQ hybrid ARQ
IAB integrated access and backhaul
ID identity/identification
IIOT industrial Internet of things
IM interference management
KPI key-performance indicator
LMF Location Management Function
LTE Long-term evolution
LTE-Uu LTE-Uu interface, One of several transport links for the LTE Positioning Protocol for a target UE with LTE access to NG-RAN.
MCG master cell group
MCS modulation coding scheme
MDT minimization of drive tests
MIMO multiple-input/multiple-output
MLR measure, log and report
MLRD MLR device
MNO mobile network operator
MR-DC multi-RAT dual connectivity
NCGI new radio cell global identifier
NG next generation
ng-eNB next generation eNB node providing E-UTRA user plane and control plane protocol terminations towards the UE, and connected via the NG interface to the 5GC
NG-RAN either a gNB or an ng-eNB
NR new radio
NR-U NR unlicensed NR operating in unlicensed frequency spectrum
NR-Uu NR-Uu interface One of several transport links for the LTE Positioning Protocol for a target UE with NR access to NG-RAN
NW Network
OAM operation and maintenance
OEM OEM original equipment manufacturer
OTT OTT over-the-top
PCI physical cell identifier Also known as PCID
PDCP packet data convergence protocol
PER packet error rate
PHY physical
PLMN public land mobile network
QCL quasi colocation
RA random access
RACH random access channel
RAN radio access network
RAT radio access technology
RF radio frequency
RIM radio access network information management
RIM-RS RIM reference signal
RLC radio link control
RLF radio link failure
RLM radio link monitoring
RP reception point
R-PLMN registered public land mobile network
RRC radio resource control
RS reference signal
RSRP reference signal received power
RSRQ reference signal received quality
RSSI received signal strength indicator
RSTD reference signal time difference
RTOA relative time of arrival
RTT round trip time
SA standalone
SCG secondary cell group
SDU service data unit
SIB system information block
SINR signal-to-interference-plus-noise ratio
SIR signal-to-interference ratio
SL side link
SNR signal-to-noise ratio
SON self-organising network
SOTA state-of-the-art
SRS sounding reference signal
SS synchronization signal
SSB synchronization signal block
SSID service set identifier
SS-PBCH sounding signal/physical broadcast channel
TAC tracking area code
TB transmission block
TDD time division duplex
TSG technical specification group
UE user equipment
UL uplink
URLLC ultra-reliable low latency communication
UTRAN universal trunked radio access network
Uu see LTE-Uu and NR-Uu
V2X vehicle-to-everything
VoIP voice over Internet protocol
WI work item
WLAN wireless local area network

1. Communication system comprising at least a first and second user device,
wherein the first and the second user devices are mobile devices and are configured to use a sidelink for a sidelink communication;
wherein the first and the second user devices are configured to commonly perform device-to-device positioning or ranging while exchanging signals via the sidelink;
wherein the communication system further comprises a coordinator; the coordinator configured to receive a sidelink-positioning request or to determine a sidelink-positioning demand and, in response to said request or to said sidelink-positioning demand, the coordinator is configured to coordinate the device-to-device positioning or ranging; wherein the first user device is configured to act as coordinator.

2. Communication system according to claim 1, wherein the first user device (e.g. comprising the sidelink-positioning demand) is configured to determine the sidelink-positioning demand and/or to initiate (request) the device-to-device positioning or ranging in response to said sidelink-positioning demand; or
wherein the second user equipment comprises the demand and is configured to transmit the sidelink-positioning request to the first user device; and/or wherein the first user device is configured to receive the sidelink-positioning request and/or to initiate the device-to-device positioning or ranging in response to said sidelink-positioning request; and/or
wherein the first user device comprises the coordinator.

3.-33. (canceled)

34. Communication system according to claim 1, wherein the second user device is a doer configured to perform one or more parts of the device-to-device positioning or ranging; and/or
wherein the second user device is a doer configured to perform as part of the device-to-device positioning or ranging a measurement, or to provide a reference signal, or to provide a reference anchor, or to forward a sidelink reference anchor, or to forward a configuration information, or to forward a measurement resource configuration information, or to forward a measurement configuration information or forward a measurement result or to provide a report on the device-to-device positioning or ranging or on a measurement of the device-to-device positioning or ranging.

35. Communication system according to claim 1, wherein the coordinator is configured to control the second user device with respect to the device-to-device positioning or ranging by use of a measurement resource configuration information and/or by use of a measurement configuration information; and/or
wherein the coordinator is configured to inform the second user device on one or more of the following information:
Sidelink positioning resource configuration;
measurement configuration;
report configuration;
transmission procedure;
measurement protocol;
measurement report;
time anchor(s);
positioning reference signals (PRS).

36. (canceled)

37. Communication system according to claim 1, wherein the coordinator is configured to determine a position information for the second user device, or to collect measurements for the second user device or for another doer; and/or
to trigger a transmission, to trigger a transmission of a reference signal, to forward a reference signal, to trigger a measurement event to be performed by the second user device or another doer or to trigger the second user device or another doer; and/or
to provide a report on the device-to-device positioning or ranging or on a measurement of the device-to-device positioning or ranging; and/or
wherein the coordinator is configured to support or assist the device-to-device positioning or ranging to determine a position information for the second user device, or to collect measurements for the second user device or for another doer; and/or
wherein the coordinator is configured to respond on a received signal with a transmission or to respond on a received signal with a transmission of a reference signal, or to perform and/or assist a measurement for the second user device or another doer or to respond to a received trigger signal by the second user device or by another doer; and/or
wherein the coordinator is configured to provide a report on the device-to-device positioning or ranging or on a measurement of the device-to-device positioning or ranging.

38. Communication system according to claim 1, wherein the device-to-device positioning or ranging comprising a sidelink measurement; and/or
wherein the device-to-device positioning or ranging comprises a sidelink measurement performed by the first or the second user device, wherein the sidelink measurement comprise at least one of the groups comprising:
two-way ranging or two-way ranging using a reference signal;
one way ranging with time anchor or one way ranging with time anchor using a reference signal;
one way ranging with signal strength anchor or one way ranging with signal strength anchor using a reference signal;
one way ranging based on RSSI path loss estimation or one way ranging based on RSSI path loss estimation using a reverence signal;
one-way or two-way ranging based on time-of-flight determination;
determining an angle of arrival and/or angle of departure;
determining a relative position or distance between the first and the second user device and/or determining an absolute position of the first or second user device or to determine a position of an anchor or of a reference point by use of one-way or two-way ranging;
determining a relative position or distance between the first and the second user device without time anchor, without reference anchor and/or an absence of line of sight between the first and the second user device and/or in the presence of ling of sight between the first and second user device by use of one-way or two-way one way ranging;
determining a relative position of the first user device with respect to another entity of the communication system or determining a relative position of the second user device with respect to another entity of the communication system; or
determining an absolute position by use of an anchor, or reference anchor, wherein an information on the anchor, or reference anchor is comprised by a measurement configuration information.

39. Communication system according to claim 1, wherein the first and/or the second user device is configured to forward an information on an anchor, time anchor or reference anchor via the sidelink; and/or
wherein the forwarding is initiated by the coordinator; and/or
wherein an information on the anchor, or reference anchor is comprised by a measurement configuration information; and/or
wherein the measurement resource configuration information comprises at least one of the following parameters:
a spatial filter or beam direction for the transmission of one or more sidelink resource(s) and/or one or more ID(s) of the one or more sidelink resource(s);
spatial filter direction comprising an indication of an identifier for a UL SRS, or a DL RS resources (PRS, CSI-RS or SSB) (so that a user device is enabled to apply an indication of spatial filter direction to a transmission or reception of an indicated resource);
spatial filter direction comprises an indication of an identifier for a SL-RS resource (so that a user device is enabled to apply an indication of a spatial filter direction to a transmission or reception of an indicated resource);
list of sidelink resources to be added or removed;
number of sidelink resources per set for positioning:
triggering types for the sidelink resources (e.g. Periodic, SP: Semi-Persistent, Aperiodic);
sidelink resource power control parameters;
sidelink timing information;
resources to be used for an out of coverage scenario.

40. (canceled)

41. (canceled)

42. Communication system according to claim 1, wherein the measurement configuration information comprises at least one of the following parameters:
information on anchor, a time anchor or reference anchor;
information on a reference signal;
and/or
wherein the measurement configuration information is received over a higher layer interface and/or from a localization server (RRC, MAC-CE, DCI for the case the configuration entity being a gNB or PC5 (Sidelink) interface for the case the configuration entity being a second sidelink device).

43. Communication system according to claim 1, wherein the device-to-device positioning or ranging is enhanced by an uplink measurement and/or a downlink measurement; and/or
wherein the measurement configuration information comprises information on uplink resources to be used for uplink measurement and/or on a downlink resources to be used as downlink measurement; and/or
wherein the uplink measurement and/or a downlink measurement is performed in collaboration to a transmission point serving as reference anchor.

44. (canceled)

45. Communication system according to claim 1, wherein the first and/or the second user device are configured to generate a report on the sidelink measurement, uplink measurement and/or downlink measurement to be forwarded to a localization server; and/or
wherein the report is generated and transmitted by the first user device as coordinator or wherein the report is generated and transmitted by the second user device as doer and initiated by the coordinator; and/or
wherein the report comprises information on one or more measurement instances or on one or more measurement instances with one or more timestamps and/or an indication or offset information of the timestamps with respect to a time anchor.

46. Communication system according to claim 1, wherein the user device out of a plurality of user devices is selected as first user device as coordinator based on one of the following criteria:
requirement of the UE for a measurement or position determination;
request by a localization server;
a pre-configuration;
a capability of the user device a Uu capability of the user device, a sidelink capability of the user device;
a position of the user device within the network;
a reachability of the user device within the network or a reachability of the user device within the network via sidelink;
a signal strength received by the user device from other devices;
signal strengths received from the user device at other devices;
a condition of a connectivity graph between the user device and other devices.

47. Communication system according to claim 1, wherein the coordinator is configured to receive measurement resource configuration information from the gNB and/or to receive measurement configuration information from a localization server; and/or
wherein the device-to-device positioning or ranging comprises the determination of the position based on measurements, wherein the determination is performed by the localization server, or by the first user device or by the coordinator or by the second user device as doer; and/or
wherein the eNB or the localization sever is configured to coordinate as coordinator or to provide measurement resource configuration information or to provide measurement configuration information.

48. (canceled)

49. Communication system according to claim 1, wherein the coordination is based on a preconfigured default setting defining measurement resource information and/or defining measurement configuration information; or
wherein the coordination performed by to coordinator is based on preconfigured default settings defining measurement resource configuration information and/or measurement configuration information, if the first and the second user device are out of coverage and/or if the first and the second user device are partially out of coverage.

50. Communication system according to claim 1, further comprising an additional coordinator; and/or
further comprising another network entity, an eNB and/or a localization server (1038) (manager); and/or
wherein the coordinator is configured to exchange information with other communication system entities dependent on a communication mode, which is defined by the presence of other entities of the communication system, wherein the other entities are of different types; and/or
wherein the first and the second user device are configured to inform on capability with respect to coherent and/or simultaneous and/or sequential transmission and/or reception and/or with respect to transmission and/or reception of one or more uplink or downlink or sidelink resources and/or with respect to a member of supported sidelink resource sets for sidelink positioning; and/or
wherein the first and the second user device are configured to inform on capability, for the first and/or the second user device and/or a gNB or other (third) network entity for coherent and/or simultaneous and/or sequential transmission and/or reception on the sidelink PRS and/or UL-SRS transmission and/or DL-PRS reception; and/or
wherein the first and the second user device are configured to inform on ranging capability, on capability comprising ranging modes, on a role (Doer or Coordinator) indication in the ranging process, on a response request according to a mode, or on an implicit mode selection by the doer when detecting several different modes.

51. (canceled)

52. (canceled)

53. First user device of a communication system according to claim 1, wherein the first user device is a mobile device and is configured to act as coordinator and is configured to:
receive a measurement resource configuration information comprising an information on a sidelink reference signal;
initiate/control/support the second user device based on the measurement resource configuration information;
receive a measurement configuration information;
apply the measurement configuration to perform the sidelink measurement together with the second user device (receive from the second user device the reference signal); and/or
report on the sidelink measurement; or
wherein the first user device is configured to support the second devices without measurement reporting.

54. (canceled)

55. First user device according to claim 53, wherein the first user device acting as coordinator is configured to perform one or more of the following functionalities:
forwarding a sidelink measurement report from a second user device to the location server;
receiving a measurement report from a second user device and/or determining a range or distance related information;
receiving a first message comprising sidelink measurement report from a second device and a second message comprising information on the transmitted signal or/and received signal characteristics from the second user device; and
determining from the two messages an estimate related to position of the first on second device;
and/or
wherein the first user device acting as coordinator is configured to trigger and/or respond to a sidelink-positioning-request to perform one or more of the following functionalities:
forwarding a sidelink measurement report from a second user device to the location server;
receiving a measurement report from a second user device and/or determining a range or distance related information;
receiving a first message comprising sidelink measurement report from a second device and a second message comprising information on the transmitted signal or/and received signal characteristics from the second user device; and
determining from the two messages an estimate related to position of the first on second device.

56. Second user device of a communication system according to claim 1, wherein the second user device is a mobile device and is configured to act as doer and is configured to:
receive a measurement resource configuration information comprising an information on a sidelink reference signal from the coordinator;
receive a measurement configuration information from the coordinator;
apply the measurement configuration to perform the sidelink measurement together with the first user device.

57. First or second user device of a communication system comprising at least the first and the second user device,
wherein the first and the second user devices are mobile devices and are configured to use a sidelink for a sidelink communication;
wherein the first and the second user devices are configured to commonly perform device-to-device positioning or ranging while exchanging signals via the sidelink;
wherein the communication system further comprises a coordinator; the coordinator configured to receive a sidelink-positioning request or to determine a sidelink-positioning demand and, in response to said request or depending or to said sidelink-positioning demand, the coordinator is configured to coordinate the device-to-device positioning or ranging.

58. First or second user device according to claim 57, wherein the first user equipment is configured to receive a sidelink-positioning request so as to act as coordinator in response to said request and to provide sidelink positioning resource configuration.

59. A method coordinating a device-to-device positioning or ranging within a system according to claim 1, comprising exchanging measurement resource configuration information or measurement configuration information between the first user equipment being a mobile device as a coordinator and at least the second user device.

60. A non-transitory digital storage medium having a computer program stored thereon to perform the method coordinating a device-to-device positioning or ranging within a system according to claim 1, comprising exchanging measurement resource configuration information or measurement configuration information between the first user equipment being a mobile device as a coordinator and at least the second user device 1020 when said computer program is run by a computer.

61. Communication system according to claim 1, wherein the first user device is configured to coordinate the device-to-device positioning or ranging based on already known sidelink positioning resource configuration and/or measurement configuration and/or by starting the device-to-device positioning or ranging (without prior configuration of the other device); and/or
wherein the first user device is configured to coordinate the device-to-device positioning or ranging by providing a transmit signal as a reference point or transmitting a transmit signal as a reference point to preconfigured user devices (without any need to configure anything).
